(19) United States
(12) Patent Application Publication
(10) Pub. No.: US 2012/0059671 A1
(43) Pub. Date: Mar. 8, 2012

(54) SYSTEM FOR REAL TIME RECORDING AND REPORTING OF EMERGENCY MEDICAL ASSESSMENT DATA

(76) Inventors: William Park, Rolling Hills Estates, CA (US); Paula Gonells, Rolling Hills Estates, CA (US)

(21) Appl. No.: 13/225,436

(22) Filed: Sep. 3, 2011

Related U.S. Application Data
(60) Provisional application No. 61/381,028, filed on Sep. 8, 2010.

(51) Int. Cl. G06Q 50/00

(52) U.S. Cl. 705/3

(57) ABSTRACT

A portable touch-sensitive system for capturing Electronic Medical Data (EMD) to create Emergency Medicine Electronic Medical Records (EMRs) that includes Graphical User Interface (GUI) menus adapted specifically for collecting and reporting medical assessments in the Emergency Room (ER) environment. For navigation, the GUI menus use text objects that can be selected, opened and moved among multiple states using simple operator pen gestures. The resulting EMR content is fully accessible without scrolling, opening or closing windows, or changing menus, making it possible to capture, in real time as the patient is talking, a EMR that fully conforms to the predetermined EMD requirements of an Emergency Medicine EMR specification.

### CROSS-REFERENCES TO RELATED APPLICATIONS

This application is filed pursuant to 37 C.F.R. §1.53(b) and claims the benefit under 35 U.S.C. §119(e) of U.S. Provisional Application No. 61/381,028 filed Sep. 8, 2010 and entirely incorporated herein by reference.

### BACKGROUND OF THE INVENTION

1. Field of the Invention

This invention relates generally to Electronic Record Management (EMR) systems and more particularly to an EMR system with a touch-sensitive Graphical User Interface (GUI) adapted for real-time recording and reporting of Emergency Medical Data (EMD) in the Emergency Room (ER) environment.

2. Description of the Related Art

Many Electronic Medical Records (EMR) systems are currently known and used in the medical services industry. Some of these systems are useful for certain medical specialties but generally lack many of the practical features required for utility in the hospital Emergency Room (ER) setting. EMR systems are still relatively recent in the art and, while evolving, there remain many clearly felt problems. There are template and open-ended charting systems having customized client criteria. Ease of implementation varies dramatically depending on chart design, prior ER computerization, record flow, actual time required to document the record and quality of training.

The physician documentation part of existing EMR systems is cumbersome and difficult to use. In certain settings and particularly in the ER, physician documentation is known to cause so much delay in effective patient care that many ER physicians are forced to chose between EMR data collection and life-saving patient care, often obliging the ER physician to use less effective paper charting that is later uploaded into the EMR system after its timely utility to other EMR system users is lost.

Currently, most EMR systems are stationary, obliging the ER physician to either push a large computer on a cart or take notes on paper and input the information in the computer at a later time. The few EMR systems implemented with a portable client computer employ Graphical User Interfaces (GUIs) that make data entry cumbersome because of the many scrolling and window opening and closing operations required to support the Emergency Medical Data (EMD) entry process.

These EMD entry procedures are also burdened with one or more government regulatory specifications for an Emergency Medicine EMR that set forth a number of predetermined EMD requirements, such as the guidelines for coding and reporting using the International Classification of Diseases, 10th Revision, Clinical Modification (ICD-10-CM) promulgated by the Centers for Medicare and Medicaid Services (CMS) and the National Center for Health Statistics (NCHS), two departments within the U.S. Department of Health and Human Services (DHHS). These guidelines are entirely incorporated herein by reference and are often used as a companion document to the DHSS CMS publication entitled “1997 Documentation Guidelines for Evaluation and Management Services,” which is entirely incorporated herein by reference and is available at https://www.cms.gov/MLNProudcts/Downloads/MASTER1.pdf. These detailed regulatory requirements must be navigated by the physician and/or the scribe while also navigating the system user interface to enter information when distracted by the busy ER environment.

The medical services art is replete with proposals for EMR system improvements for many purposes, including insurance cost optimization (e.g. U.S. Pat. No. 7,379,885 issued to Zakim), patient diagnosis and monitoring (e.g. U.S. Pat. No. 7,409,154 issued to Putnam et al.), automatic EMR update and maintenance (e.g. U.S. Pat. No. 7,464,043 issued to Dussia), automatic integration of disparate databases (e.g. U.S. Pat. No. 7,707,047 issued to Hasan et al.), ER cost control (e.g. U.S. Patent Application No. 2003/0,069,756 published by Higgenbotham et al) and many others. Many practitioners have proposed solutions to one or more of several well-known deficiencies in the EMR system arts but, until now, little attention was given to the problem of regulation-compliant EMD entry and review in the busy ER setting that may delay effective patient care to the point where the ER physician must choose between compliant EMD collection and life-saving patient care.

For example, in U.S. Pat. No. 6,154,750, Roberge et al. disclose a method and system for navigating hierarchical database views that supports efficient entry, review, and updating of data using a navigation display. Roberge et al. teach a useful method for the entry, review and update of data in a hierarchically-organized database but neither consider nor suggest solutions to the specific problems of EMD entry and review in the ER setting.

In U.S. Pat. No. 6,347,329, Evans discloses an EMR system having a patient data repository in communication with the point of care system that captures patient data, such as patient complaints, lab orders, medications, diagnoses, and procedures, at its source at the time of entry using a touch-screen graphical user interface (GUI) or pen-based portable computers with wireless connections to a computer network. Evans does not consider the ER environment as his teachings require a permanent (wireless or wired) connection between the point-of-capture elements and a patient data repository. Evans neither considers nor suggests solutions to the specific problems of EMD entry and review in the ER setting where such communications are often erratic and unreliable.

In U.S. Patent Application No. 2008/0,242,953, Dew et al. disclose an automated system for guiding a user's examination of a patient and for generating a transcript. Dew et al. teach a useful method for efficient production of compliant EMRs but neither consider nor suggest solutions to the specific problems of EMD entry and review in the ER setting.

In U.S. Pat. Nos. 6,684,276 and 7,461,079, Walker et al. disclose a patient encounter EMR system that includes pre-populated, diagnosis specific templates, selective, specialty-specific master databases, and anatomic specific databases and templates to afford comprehensive, accurate and compliant medical documentation that captures patient data concurrently with the clinical patient encounter session. Again, Walker et al. teach a useful method for efficient production of compliant EMRs but neither consider nor suggest solutions to the specific problems of EMD entry and review in the ER setting.

In U.S. Pat. Nos. 7,225,131 and 7,499,862, Bangalore et al. disclose an EMR system that uses a flexible multimodal interactive environment for entering medical information into a computer device. But effective operation of Evans' invention requires a synchronized combination of at least two modes of user inputs into the EMR system, which does not consider nor suggest solutions to the specific problems of EMD entry and review in the ER setting where more than one user input mode may not be readily useable.

There remains a clearly felt need in the art for effective solutions to the specific problems of EMD entry and review in the ER setting. The EMD problems are so acute that they have engendered a nation-wide industry of ER Scribes who are especially trained to assist ER physicians with EMD documentation compliance for patient ER visits. The duties and specialization are so demanding that a single ER scribe can assist only one ER physician per shift.

These unresolved problems and deficiencies are clearly felt in the art and are solved by this invention in the manner described below.

### SUMMARY OF THE INVENTION

This invention solves these Emergency Medicine Electronic Medical Record (EMR) management problems by introducing, for the first time, a portable touch-sensitive EMR client system that includes a gesture-operated Graphical User Interface (GUI) adapted specifically for collecting and reporting the Emergency Medical Data (EMD) needed for proper medical assessments in the Emergency Room (ER) environment. The method and system of this invention arose from the unexpectedly advantageous observation that providing a portable EMR client with a gesture-optimized GUI and independent local processing that is optimized according to an Emergency Medicine Electronic Medical Records (EMR) specification (such as, for example, the Medicare Coding and Reporting Guidelines) can resolve many of the well-known problems of compliant EMD entry and review in the ER setting.

It is a feature of the system of this invention that the GUI includes gesture and handwriting recognition features optimized for use with tablet computers.

It is another feature of the system of this invention that the user may use an electronic pen to tap and slash menu items displayed on a touch screen as command gestures sufficient to complete and record the compliant EMD.

It is another feature of the system of this invention that the GUI uses text objects as menu items for navigation. The text object can be selected, opened and moved among multiple states by means of pen gestures; e.g., click for positive, slash for negative, second click on a selected object to open a panel.

It is a purpose of this invention to provide for EMR input and storage in real time. The inventors recognized that a lot of information is thrown at the EMR system user rapidly and randomly during ER history taking. For example, the patient may tell the user something that belongs in Social History while the user is recording the patient's History of Present Illness (HPI), perhaps forcing the user to take paper notes for later input or lose time changing windows and miss some of the information. The system of this invention organizes all of the history entry on the same GUI menu, allowing the user to quickly follow EMD from the patient in any sequence. The assessment report is generated instantaneously as the user taps on the GUI menu items (e.g., text words) and may be reviewed by the user upon simply touching the GUI menu so that the user's EMD entry speed is limited only by the patient's reporting speed.

The system of this invention preferably provides extensive content specific to Emergency medicine that is easily accessible and organized in GUI submenus linked to textual menu item objects to map the real world thought processes of the ER physician.

For the first time, the system of this invention provides a GUI that is adapted for immediate use by ER scribes with limited medical knowledge. The system of this invention is the first EMR system that provides for ER scribes as users and allows both the physician and ER scribe to share patient charting activities in real time.

It is an advantage of the system of this invention that it operates without any browser delays because it is a hybrid system that is separately connected to a remote server (e.g., by the Internet). The remote server EMD synchronization permits simultaneous access by multiple users to the most current version of an EMR chart in progress. However, the local selection of menu item text objects within a local GUI menu is independent of the remote server connection. Thus, when the local computer loses connectivity, the user may continue EMD entry without GUI menu delays.

In one aspect, the invention is a machine-implemented method for capturing Emergency Medical Data (EMD) in accordance with an Emergency Medicine Electronic Medical Records (EMR) specification comprising a plurality of predetermined EMD requirements in a client computer having a local processor for accepting commands and data, a local memory coupled to the local processor, and a touch-screen coupled to the local processor and local memory for displaying at least one of a plurality of Graphical User Interface (GUI) menus each having one or more menu items and for detecting operator gestures linked to one or more displayed GUI menu items, including the steps of (a) producing for display by the touchscreen one or more of the plurality of GUI menus each having one or more menu items, (b) transferring commands and data to the local processor responsive to one or more operator gestures received at the touch-screen, and (c) modifying one or more menu items in a GUI menu responsive to captured EMD with respect to a predetermined EMD requirement, whereby EMD conforming to the EMR specification are captured and stored in the local memory.

In a preferred embodiment, the invention is an Emergency Medicine Electronic Medical Records (EMR) system for capturing Emergency Medical Data (EMD) conforming to an Emergency Medicine EMR specification comprising a plurality of predetermined EMD requirements, including a client computer having a local processor for accepting commands and data, a local memory coupled to the local processor, and a touch-screen coupled to the local processor and local memory for displaying at least one of a plurality of Graphical User Interface (GUI) menus each having one or more menu items and for detecting operator gestures linked to one or more displayed GUI menu items, where the local processor includes processing for producing one or more of the plurality of GUI menus each having one or more menu items for display by the touch-screen, processing for generating commands and data responsive to one or more operator gestures received at the touch screen, and processing for modifying one or more menu items in a GUI menu responsive to captured EMD with respect to a predetermined EMD requirement, whereby EMD conforming to the EMR specification are captured and stored in the local memory.

The foregoing, together with other objects, features and advantages of this invention, can be better appreciated with reference to the following specification, claims and the accompanying drawing.

### BRIEF DESCRIPTION OF THE DRAWINGS

For a more complete understanding of this invention, reference is now made to the following detailed description of the embodiments as illustrated in the accompanying drawing, in which like reference designations represent like features throughout the several views and wherein:

FIG. 1 is a schematic diagram illustrating an exemplary embodiment of the Emergency Medicine Electronic Medical Records (EMR) system of this invention;

FIG. 2 is a schematic diagram illustrating an exemplary embodiment of the touchscreen element showing the Graphical User Interface (GUI) display and the gesture input elements of the exemplary embodiment of FIG. 1;

FIGS. 3A-B are schematic diagrams illustrating the appearance and operation of the Word Selection command element of the GUI menu display and gesture command system of the exemplary embodiment of FIG. 1;

FIGS. 4A-B are schematic diagrams illustrating the appearance and operation of the Word Deselection command element of the exemplary embodiment of FIG. 1;

FIGS. 5A-B are schematic diagrams illustrating the appearance and operation of several alternative Free Text Input elements of the exemplary embodiment of FIG. 1;

FIG. 6 is a schematic diagram and description of a Physical Exam Page element of the exemplary embodiment of FIG. 1 showing exemplary body system menus;

FIG. 7 is a schematic diagram illustrating an exemplary embodiment of the EMD capturing method of this invention;

FIG. 8 is a schematic diagram illustrating an exemplary embodiment of the gesturing command and data input method of this invention; and

FIG. 9 is a schematic diagram illustrating an exemplary embodiment of the Computer Program (CP) product of this invention.

### DETAILED DESCRIPTION OF THE EMBODIMENTS

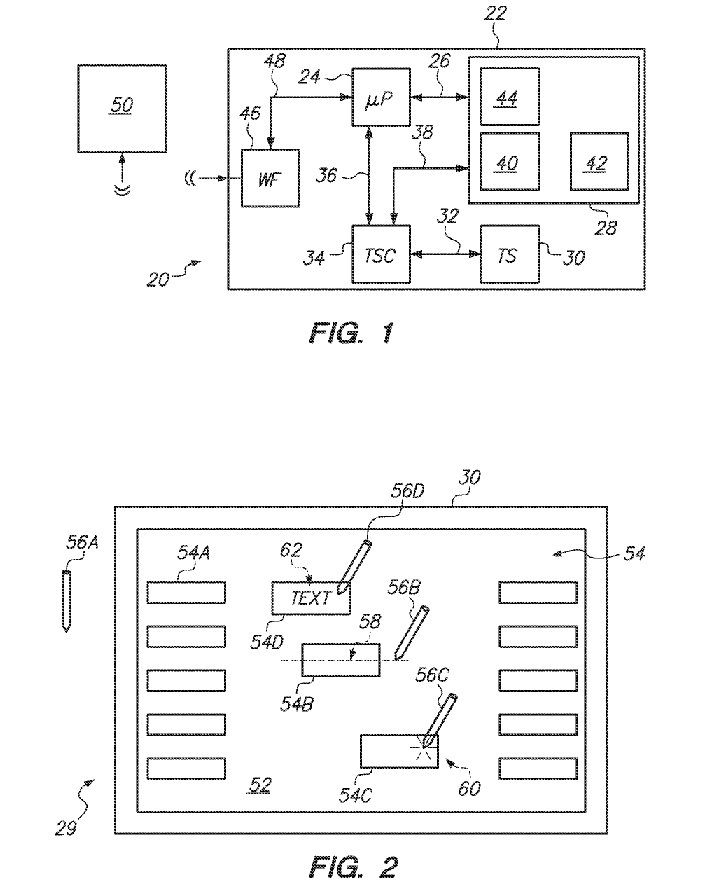

FIG. 1 is a schematic diagram illustrating an exemplary embodiment 20 of the Emergency Medicine Electronic Medical Records (EMR) system of this invention. Embodiment 20 includes a client computer 22 having a local processor 24 that is coupled by a command and data bus 26 to a local memory 28. Client computer 22 also includes a touch screen 30 coupled by a command and data bus 32 to a touch screen controller 34, which transfers commands and data between touch screen 30 and local processor 24 by way of the command and data bus 36. Touch screen controller 34 is also coupled to local memory 28 by the command and data bus 38 to permit direct communication under processor control. Local memory 28 stores programs and data such as, without limitation, the exemplary Emergency Medical Data (EMD) 40, the exemplary group of program objects 42 representing instructions for testing EMD 40 for compliance with a plurality of predetermined EMD requirements that compose an exemplary Emergency Medicine EMR specification and the exemplary group of program objects 44 representing one or more of the plurality of GUI menus for display or for generating commands and data responsive to one or more operator gestures detected at touch screen 20 or for modifying a menu item in a GUI menu responsive to EMD 40 in view of an EMD requirement in program objects 42, for example. Program objects 40-44 are preferably embodied as C++ framework class instances, for example, and may be embodied as suitable instances of any other suitable object-oriented framework classes known in the art, for example. Finally, the WiFi modem 46 is coupled to local processor 24 by the command and data bus 48 to permit local computer 22 to exchange commands and data with the remote server computer system 50 in the usual manner. Note that remote server computer system 50 need not be coupled to client computer 22 to facilitate capture of EMD 40 as all necessary system elements reside within client computer 22. Client computer 22 is preferably embodied as a Motion Computing C5v Tablet PC, for example, and may be embodied as any other suitable tablet computer adapted for medical use known in the art, for example.

FIG. 2 is a schematic diagram illustrating an exemplary embodiment of touchscreen 30 showing the Graphical User Interface (GUI) 52 that is adapted to display a GUI menu 54 having several menu items exemplified by the menu item 54A and to accept input from touch contact with GUI 52 by, for example, the pen 56A. The operator may present to GUI 52 an operator gesture exemplified by the slash stroke gesture 58 formed by moving a pen 56B in contact with touch screen 30 to describe slash stroke 58 across a displayed menu item 54B substantially as shown. Gesture 58 is said to be “linked” to menu item 54B by the spatial coincidence of the operator gesture and the menu item display. Touch screen 30 accepts any operator gesture detected by the touch-sensitive surface of touch screen 30 and transfers the data to touch screen controller 34 for conversion to commands and data under program control (FIG. 1). Other useful operator gestures include the tapping gesture 60 presented by tapping a displayed menu item 54C with a pen 56C, for example, and the handwritten text gesture 62 presented by moving a pen 56D to form text in contact with a displayed menu item 54D, for example. Each of these operator gestures results in the transfer of one or more commands or data from touch screen controller 34 to local memory 28 or local processor 24, for example (FIG. 1). According to a preferred embodiment, a proper slash stroke gesture requires the operator to approach the menu item with the pen until a menu item box is encountered, touch one end of the menu item box at left or right, and slash horizontally across the vertical centerline of the menu item box.

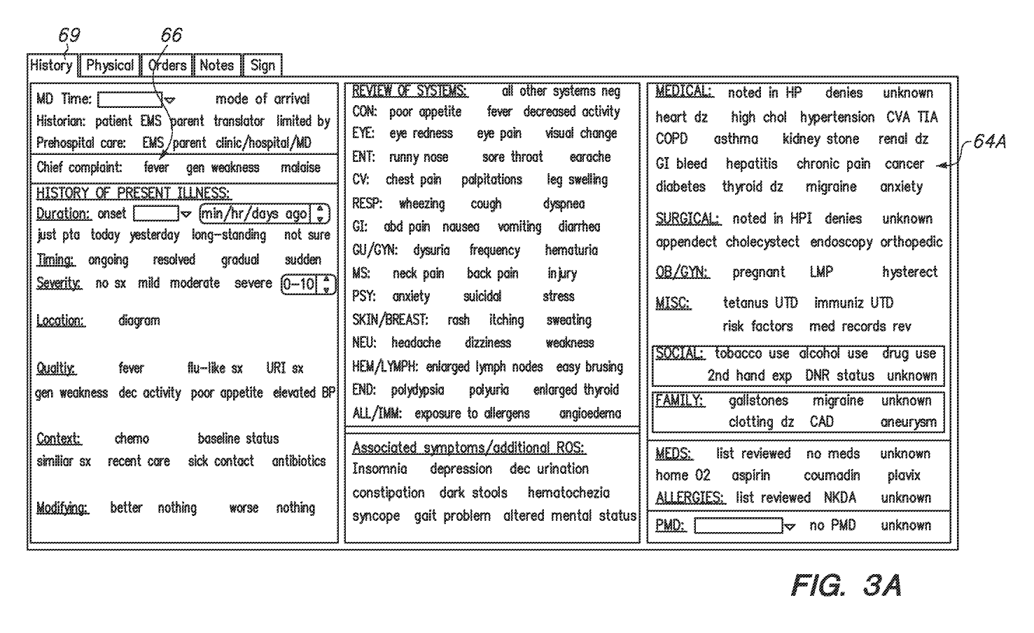

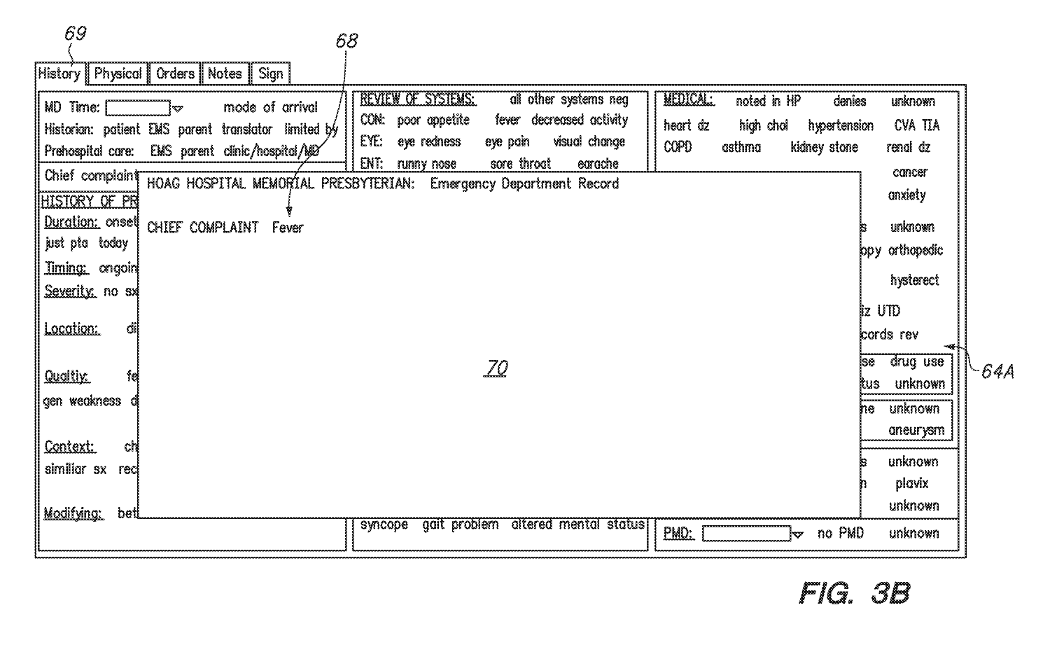

FIG. 3A is a schematic diagram illustrating a preferred embodiment of the Word Selection command element of this invention using the History menu 64A. History Menu 64A includes many textual menu items exemplified by the Fever menu item 66. When the operator taps on Fever menu item 66, the color changes to green, for example, to indicate the generation of a first selection command linked to Fever menu item 66. Additionally, as shown in FIG. 3B, the selection of Fever menu item 66 causes the addition of the “Fever” text 68 to an EMD record 70 in local memory 28 (FIG. 1) reflecting a positive Fever history. Finally, the color of the History Menu Icon 69, for example, preferably indicates when the EMD captured during the interview satisfy all predetermined EMD requirements of the Emergency Medicine EMR specification (e.g., when Medicare Level 5 Coding is satisfied). An auditory signal to the operator is also useful for this purpose, for example, as is any other suitable indication readily available to the operator.

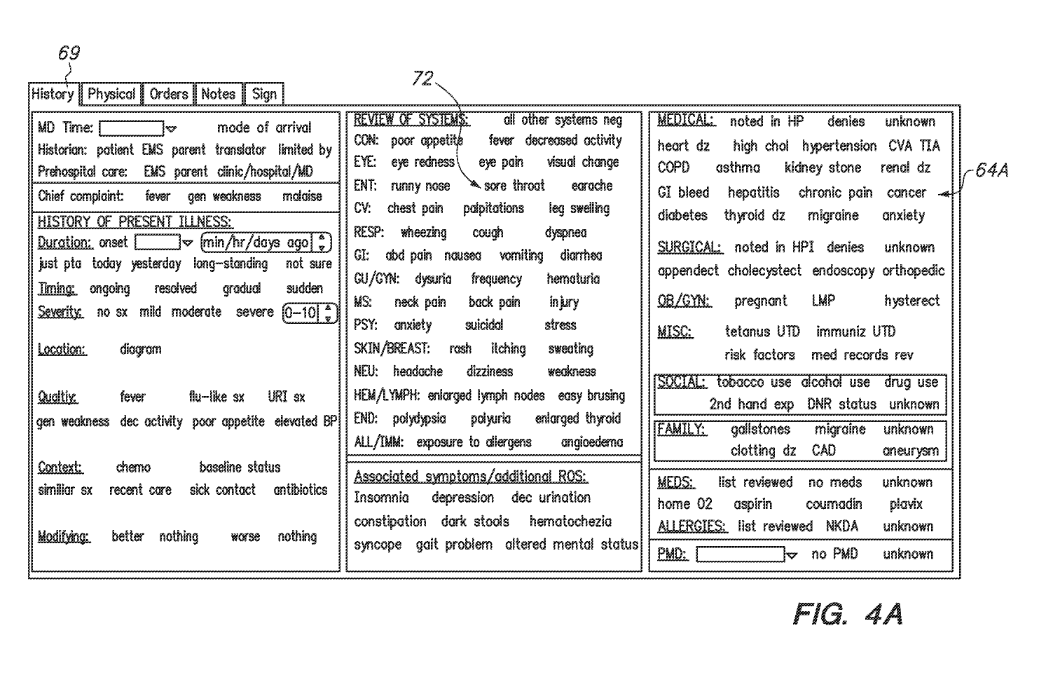

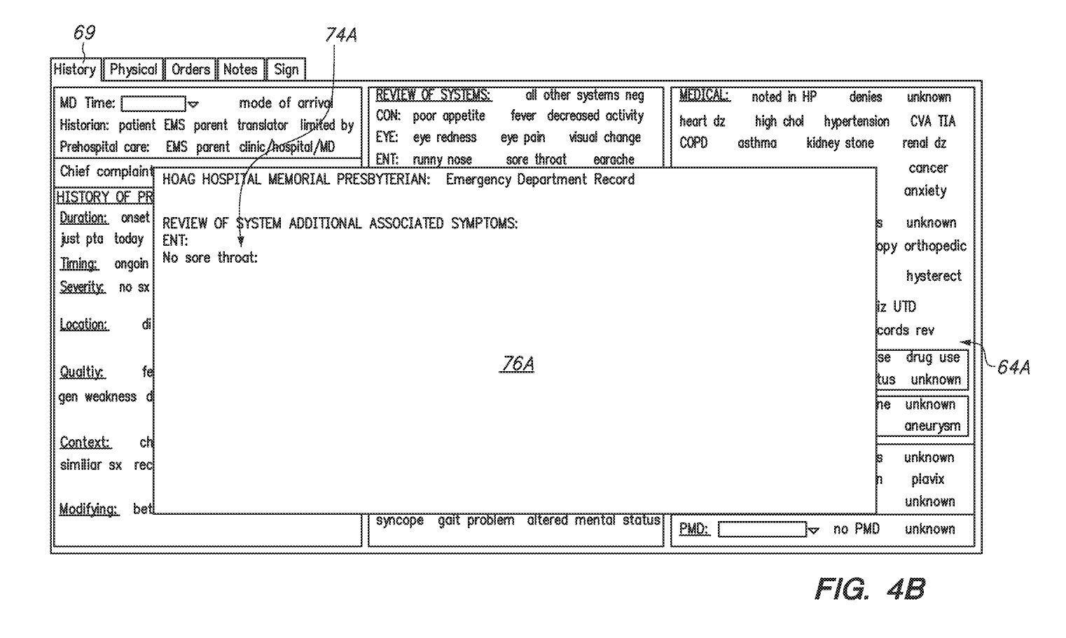

FIG. 4A is a schematic diagram illustrating a preferred embodiment of the Word Deselection command element of this invention using History menu 64. History Menu 64 includes many textual menu items exemplified by the Sore Throat menu item 72. When the operator slashes through Sore Throat menu item 72, the color changes from black to green, for example, to indicate the generation of a second deselection command linked to Sore Throat menu item 72. Additionally, as shown in FIG. 4B, the deselection of Sore Throat menu item 72 causes the addition of the “No Sore Throat” text 74A to an EMD record 76A in local memory 28 reflecting a negative Sore Throat history. Menu items with no logical pertinent negatives are preferably locked, for example, to prevent any response to the slash stroke gesture. A selected or deselected menu item can be returned to neutral (unselected) with a second slash stroke through the selected menu item. The color is returned to, for example, black and any associated text entry in the EMD is deleted.

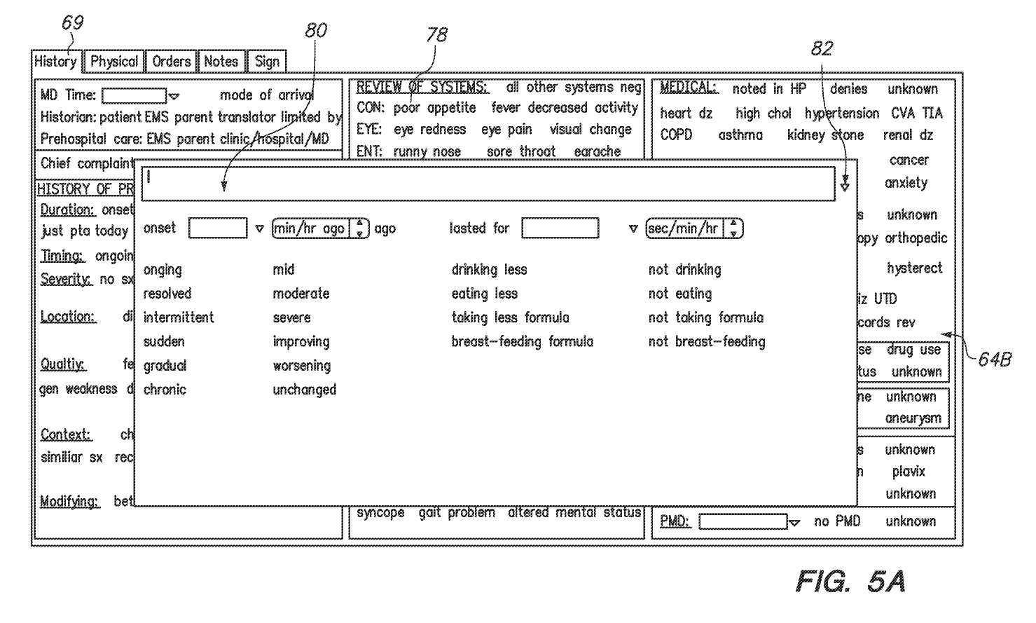

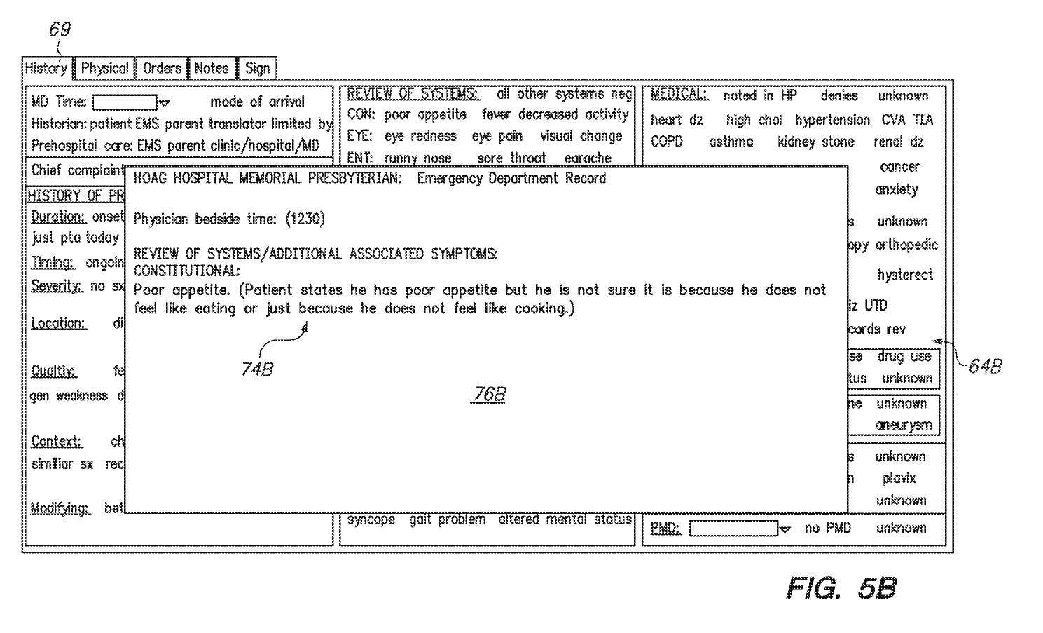

FIGS. 5A-B are schematic diagrams illustrating the appearance and operation of several alternative Free Text Input elements of system 20. In the History menu 64B of FIG. 5A, the “Poor Appetite” menu item 78 is selected by a tap gesture (not shown), which commands system 20 to change the color of menu item 78 (e.g., from black to red) and opens up a submenu window with a text entry menu item 80. The operator may tap the arrow 82 on the right side of menu item 80 to open a larger text entry area (not shown) for more space if needed or may use handwriting or speech-recognition tools to enter text in menu item 80, for example. As shown in FIG. 5B, the resulting “Poor Appetite” text 74B can be reviewed in the EMD record 76B. Text 74B includes the parenthetical text entered in menu item 80 substantially as shown.

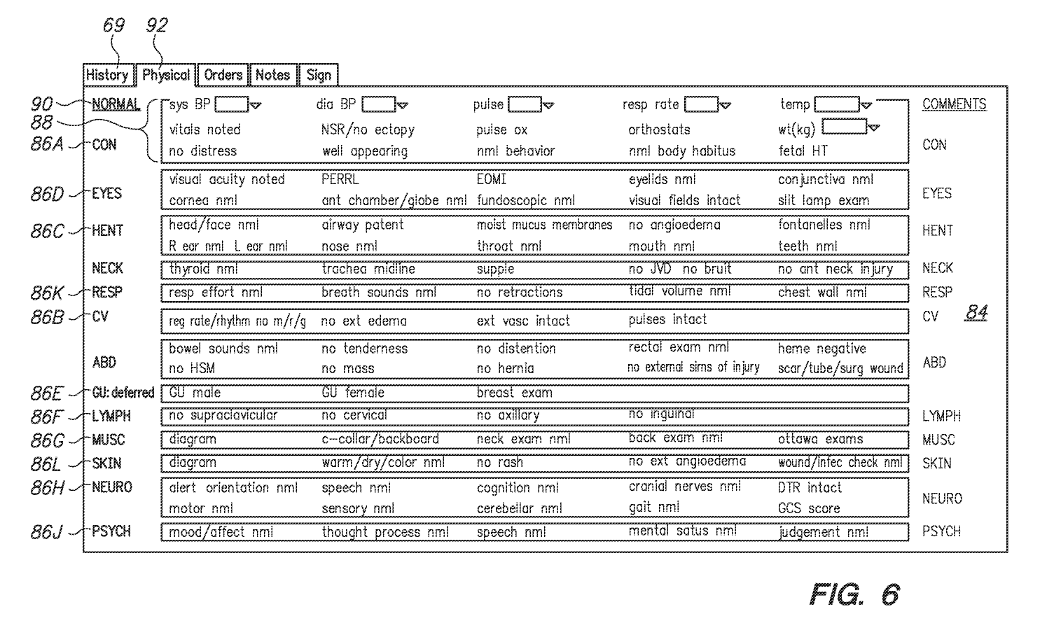

FIG. 6 is a schematic diagram and description of a Physical Exam menu 84 embodiment of the GUI menu of this invention showing menu items linked to exemplary body system menus that conform to the exemplary Medicare Emergency Medicine EMR specification incorporated herein by reference above. For example, the “CON” menu item 86A links to a plurality of menu items 88 associated with a general examination menu (CONsultation). Similar GUI icons are shown linked to groups of menu items associated with a cardiovascular examination menu (the CV menu item) 86B, an ear, nose and throat examination menu (the HENT menu item) 86C, an eye examination menu (the EYES menu item) 86D, a genitourinary examination menu (the GU menu item) 86E, a hematologic examination menu (the LYMPH menu item) 86F, a musculoskeletal examination menu (the MUSC menu item) 86G, a neurological examination menu (the NEURO menu item) 86H, a psychiatric examination menu (the PSYCH menu item) 86J, a respiratory examination menu (the RESP menu item) 86K, and a skin examination menu (the SKIN menu item) 86L, for example. After selecting all abnormal menu items individually with the appropriate operator gestures, the operator may tap the NORMAL menu item 90 to default all remaining menu items to a “normal” selection command, for example. Finally, the color of the Physical Examination Menu Icon 92, for example, preferably indicates when the EMD captured during the examination satisfy all predetermined EMD requirements of the Emergency Medicine EMR specification (e.g., when Medicare Level 5 Coding is satisfied). An auditory signal to the operator is also useful for this purpose, for example, as is any other suitable indication readily available to the operator.

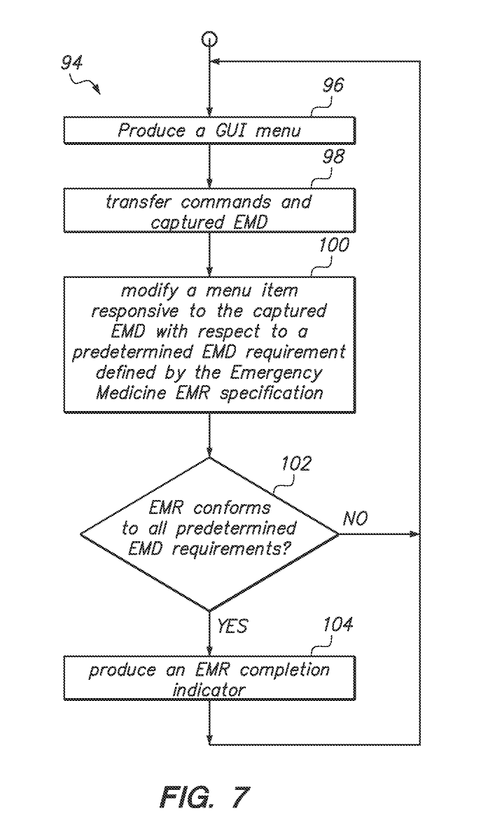

FIG. 7 is a schematic diagram illustrating an exemplary embodiment 94 of the EMD capturing method of this invention. In the first step 96, one or more of a plurality of GUI menus is produced for display to the operator on touch-screen 30 (FIGS. 1-2). In the next step 98, commands and data are captured and transferred to local processor 24 responsive to operator gestures detected by touch-screen 30 (FIGS. 1-2). In the following step 100, a menu item display is modified by system 20 to communicate to the operator any additional commands or data required (in view of the captured EMD) by a predetermined EMD requirement defined in the Emergency Medicine EMR specification (e.g., the Medicare coding requirements referenced herein above). This menu item display modification may be embodied as, for example, a new submenu display, a color change in a menu item display, an audio signal, locking or unlocking of one or more menu items, or any other useful menu modification suitable for the purposes of this invention. In the step 102, the captured EMD is tested to determine if the captured EMD is sufficient to complete an EMR that conforms to ALL predetermined EMD requirements defined in the Emergency Medicine EMR specification (e.g., the Medicare coding requirements referenced herein above). If the test in step 102 fails, the process proceeds back to step 96 as shown. If the test in step 102 succeeds and the EMD is found to be complete in the context of an applicable Emergency Medicine EMR specification, then the next step 104 is performed to produce an indication to the operator showing the captured EMD as sufficient to complete an EMR that conforms to the applicable Emergency Medicine EMR specification.

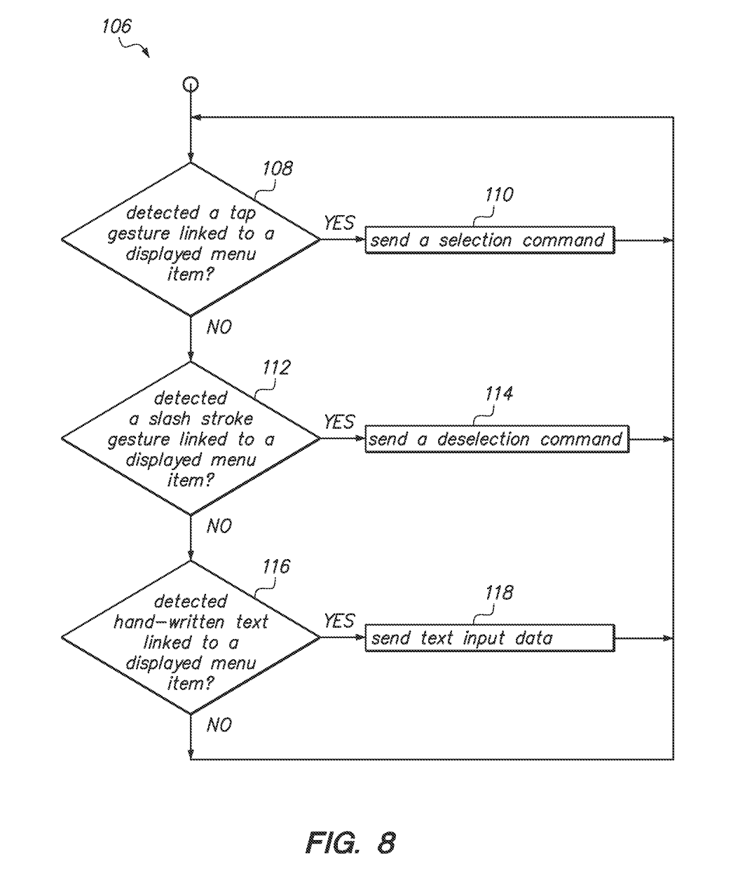

FIG. 8 is a schematic diagram illustrating an exemplary embodiment 106 of the gesturing command and data input method of this invention. Method 106 is a loop that starts at the step 108 to test for a detection of a tap gesture linked to a menu item displayed on touchscreen 30 (FIGS. 1-2). If step 108 succeeds, then the step 110 sends a selection command to system 20 for the linked menu item and the loop returns to step 108 as shown. If step 108 fails, then the loop proceeds to the next step 112, which tests for a detection of a slash stroke gesture linked to a menu item displayed on touch-screen 30 (FIGS. 1-2). If step 112 succeeds, then the step 114 sends a deselection command to system 20 for the linked menu item and the loop returns to step 108 as shown. If step 112 fails, then the loop proceeds to the next step 116, which tests for a detection of a hand-written text gestures linked to a menu item displayed on touch-screen 30 (FIGS. 1-2). If step 116 succeeds, then the step 118 sends text input commands and data to system 20 for the linked menu item. If step 116 fails, then the loop returns to step 108 as shown. Method 106 may also include steps (not shown) for detecting human speech linked to a menu item and responsively sending text input commands and data to system 20 for the linked menu item, for example.

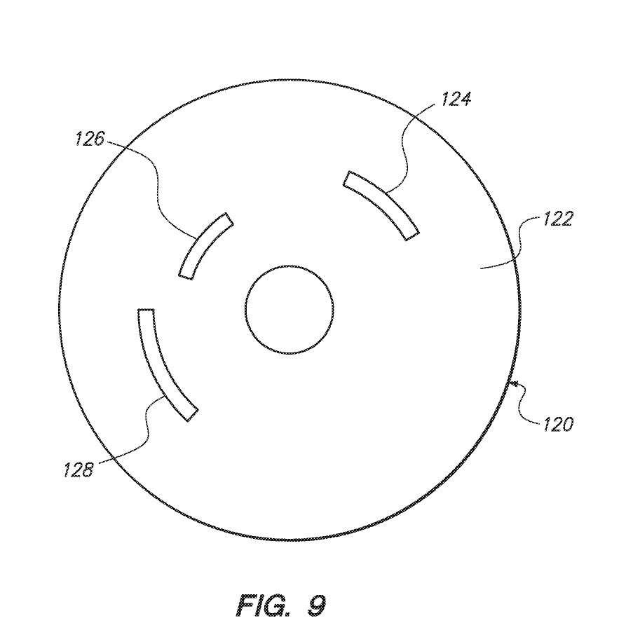

FIG. 9 is a schematic diagram illustrating an exemplary embodiment 120 of the Computer Program (CP) product of this invention. CP product 120 includes an optical data storage surface 122 adapted for the computer-readable storage and recovery of commands and data. For example, the program file 124 stored on surface 122 may include program means for directing a client computer system to transfer a menu item selection command to the local processor responsive to a slash stroke gesture linked to a displayed menu item. As another example, the program file 126 stored on surface 122 may include program means for directing a client computer system to produce and display one or more of a plurality of GUI menus. As yet another example, the program file 128 stored on surface 122 may include program means for directing a client computer system to produce and display a normal, positive or negative body system status submenu responsive to the context of captured EMD.

The system of this invention provides solutions for the most particular challenges of ER documentation, including, for example, bedside documentation, ease of use, real time documentation, depth of content, multiple patients, patient registration delays, use with scribes, interface delays found with browser based programs, system integration, data retrieval for questions/answers and research, local customization, and cost control.

Bedside documentation: The system of this invention is adaptable to advanced tablet computer systems including handwriting recognition, electronic pen technology, dual batteries for hot swapping, rubber casing to reduce heat, suspended hard drive to withstand falls, splash resistance and a quick release dock for charging and using as a desktop computer. The system is completely portable and the user need not use a mouse or sit down.

Ease of use: The system of this invention requires no computer skills and virtually no training. Within ten minutes of receiving the client computer, the user will be able to start seeing patients and even have fun charting. The revolutionary interface eliminates all cumbersome navigation techniques. All the user need to do is tap and slash words with the user's electronic pen and the user's charting will be done for the user.

Real time documentation: The system of this invention recognizes that during history taking a lot of information is thrown at the user at a fast rate and in random order. For example, the patient may tell the user something that belongs in Social History while the user are recording the user's HPI, forcing the user to take paper notes for later input or lose time changing windows and miss some of the information. With the system of this invention all the history is on the same page and the user can follow the patients wherever they go. The report is generated instantaneously as the user tap on the words and the user can check it as the user go along by just touching the screen. There is no delay in the interface: the user's limiting factor will be the user's patient's speed as a historian.

Depth of content: The system of this invention provides extensive content that is specific to emergency medicine and is easily accessible. The user chooses when to stay superficial and when to go deep. The information is all there but instead of cluttering the surface, it is organized in panels contained within the words. The system makes full use of the three-dimensional potential of a computer as compared to paper. This allows for a simple surface interface with a large amount of underground information all organized in a logical and accessible way. The information is organized to match the thought process of the physician in a real world environment.

Multiple patients: The system of this invention provides an easy to use tracking board that allows the user to go back and forth between patients. The tracking board will notify the user of the user's progress on each patient, letting the user know when x-rays and labs are back.

Delays in patient registration: The system of this invention allows the user to start charting on a patient before they are registered. This temporary record is then merged to the permanent patient chart once registration is completed.

Use with scribes: The system of this invention is endorsed by Scribe America, the largest and most experienced scribe company in the United States. The system incorporates suggestions from scribes around the country to make the system scribe friendly. The resulting system can be used immediately even by someone with limited medical knowledge, like a new scribe, for example.

Browser interface delays: The system of this invention offers all the benefits of a browser based programs, such as real time data synching and off site access, while being able to run at a speed that is not dependent on the server connection. The user will never be delayed by a lost or slow connection. The system will remain quick and responsive even if the user loses the WiFi connection while moving from room to room or if the hospital system slows down because of high usage.

System integration: The system of this invention is designed to integrate with the existing ER systems for patient registration, labs, x-ray and the hospital medical record. The system of this invention is useful as an add-on physician EMD documentation module to the user's current EMR system or as a stand-alone system. The system is a cost-effective and high-value alternative to expensive voice transcription programs, outdated paper products and existing EMR systems not adapted to the ER environment.

Data retrieving for Q/A and research: The system of this invention allows the user unmatched flexibility in tracking whatever information the user chooses. The system can be adapted to provide reports that comply with the specific demands of the user's institution.

Clearly, other embodiments and modifications of this invention may occur readily to those of ordinary skill in the art in view of these teachings. Therefore, this invention is to be limited only by the following claims, which include all such embodiments and modifications when viewed in conjunction with the above specification and accompanying drawing.

1. An Emergency Medicine Electronic Medical Records (EMR) system for capturing Emergency Medical Data (EMD) conforming to an Emergency Medicine EMR specification comprising a plurality of predetermined EMD requirements, the system comprising:
a client computer having
a local processor for accepting commands and data,
a local memory coupled to the local processor, and
a touch-screen coupled to the local processor and local memory for displaying at least one of a plurality of Graphical User Interface (GUI) menus each having one or more menu items and for detecting operator gestures linked to one or more displayed GUI menu items;
wherein the local processor includes
first processing means for producing one or more of the plurality of GUI menus for display by the touch-screen,
second processing means for generating commands and data responsive to one or more operator gestures detected by the touch screen, and
third processing means for modifying one or more menu items in a GUI menu responsive to captured EMD with respect to a predetermined EMD requirement;
whereby EMD conforming to the Emergency Medicine EMR specification are captured and stored in the local memory.

2. The system of claim 1 wherein the plurality of GUI menus comprises:
one or more menus selected from a group of body system menus defined by the Emergency Medicine EMR specification; and
one or more submenus selected from a group comprising normal, positive and negative body system status submenus for a selected body system menu.

3. The system of claim 1 wherein:
the operator gestures comprise a tap, a slash stroke, and hand-written text; and
the second processing means is adapted to produce
a first menu item selection command responsive to the detection by the touchscreen of a tap linked to a displayed menu item,
a second menu item selection command responsive to the detection by the touch-screen of a slash stroke linked to a displayed menu item, and
text input data responsive to the detection by the touch-screen of hand-written text linked to a displayed menu item.

4. The system of claim 1 wherein the group of body systems menus comprises:
a general examination menu;
a cardiovascular examination menu;
an ear, nose and throat examination menu;
an eye examination menu;
a genitourinary examination menu;
a hematologic examination menu;
a musculoskeletal examination menu;
a neurological examination menu;
a psychiatric examination menu;
a respiratory examination menu; and
a skin examination menu.

5. The system of claim 1 wherein the third processing means produces a GUI indication for display by the touch-screen when the captured EMD satisfy all predetermined EMD requirements of the Emergency Medicine EMR specification.

6. The system of claim 1 wherein:
the GUI menu items are displayed by the touch-screen as text icons.

7. A machine-implemented method for capturing Emergency Medical Data (EMD) in accordance with an Emergency Medicine Electronic Medical Records (EMR) specification comprising a plurality of predetermined EMD requirements in a client computer having a local processor for accepting commands and data, a local memory coupled to the local processor, and a touch-screen coupled to the local processor and local memory for displaying at least one of a plurality of Graphical User Interface (GUI) menus each having one or more menu items and for detecting operator gestures linked to one or more displayed GUI menu items, the method comprising the steps of:
(a) producing for display by the touch-screen one or more of the plurality of GUI menus;
(b) transferring commands and data to the local processor responsive to one or more operator gestures detected by the touch-screen; and
(c) modifying one or more menu items in a GUI menu responsive to captured EMD with respect to a predetermined EMD requirement;
whereby EMD conforming to the Emergency Medicine EMR specification are captured and stored in the local memory.

8. The method of claim 7 further comprising the steps of:
(a.1) producing for display by the touch-screen at least one of a group of body system menus defined by the Emergency Medicine EMR specification; and
(a.2) producing for display by the touch-screen at least one submenu selected from a group comprising normal, positive and negative body system status submenus for a selected body system menu.

9. The method of claim 7 wherein the operator gestures include a tap, a slash stroke, and hand-written text and further comprising the steps of:
(b.1) transferring a first menu item selection command to the local processor responsive to the detection by the touch-screen of a tap linked to a displayed menu item,
(b.2) transferring a second menu item selection command to the local processor responsive to the detection by the touch-screen of a slash stroke linked to a displayed menu item, and
(b.3) transferring text input data to the local processor responsive to the detection by the touch-screen of hand-written text linked to a displayed menu item.

10. The method of claim 7 wherein the group of body systems menus comprises:
a general examination menu;
a cardiovascular examination menu;
an ear, nose and throat examination menu;
an eye examination menu;
a genitourinary examination menu;
a hematologic examination menu;
a musculoskeletal examination menu;
a neurological examination menu;
a psychiatric examination menu;
a respiratory examination menu; and
a skin examination menu.

11. The method of claim 7 further comprising the step of:
(d) producing for display by the touch-screen an indication when the captured EMD satisfy all predetermined EMD requirements of the Emergency Medicine EMR specification.

12. The method of claim 7 wherein the GUI menu items are displayed by the touch-screen as text icons.

13. The method of claim 7 further comprising the step of:
(d) exchanging commands and data with a remote server computer.

14. A Computer Program (CP) product for use in a client computer system having a local processor for accepting commands and data, a local memory coupled to the local processor, and a touch-screen coupled to the local processor and local memory for displaying at least one of a plurality of Graphical User Interface (GUI) menus each having one or more menu items and for detecting operator gestures linked to one or more displayed GUI menu items, and including a CP system that supports execution of at least one CP application for capturing Emergency Medical Data (EMD) conforming to an Emergency Medicine Electronic Medical Records (EMR) specification comprising a plurality of predetermined EMD requirements, the CP product comprising:
a computer-readable recording medium;
means recorded on the recording medium for directing the client computer system to produce for display by the touch-screen one or more of the plurality of GUI menus;
means recorded on the recording medium for directing the client computer system to transfer commands and data to the local processor responsive to one or more operator gestures detected by the touch-screen; and
means recorded on the recording medium for directing the client computer system to modify one or more menu items in a GUI menu responsive to captured EMD with respect to a predetermined EMD requirement.

15. The CP product of claim 14 further comprising:
means recorded on the recording medium for directing the client computer system to produce for display by the touch-screen at least one of a group of body system menus defined by the Emergency Medicine EMR specification; and
means recorded on the recording medium for directing the client computer system to produce for display by the touch-screen at least one submenu selected from a group comprising normal, positive and negative body system status submenus for a selected body system menu.

16. The CP product of claim 14 further comprising:
means recorded on the recording medium for directing the client computer system to transfer a first menu item selection command to the local processor responsive to the detection by the touch-screen of a tap linked to a displayed menu item,
means recorded on the recording medium for directing the client computer system to transfer a second menu item selection command to the local processor responsive to the detection by the touch-screen of a slash stroke linked to a displayed menu item, and
means recorded on the recording medium for directing the client computer system to transfer text input data to the local processor responsive to the detection by the touch-screen of hand-written text linked to a displayed menu item.

17. The CP product of claim 14 wherein the group of body systems menus comprises:
a general examination menu;
a cardiovascular examination menu;
an ear, nose and throat examination menu;
an eye examination menu;
a genitourinary examination menu;
a hematologic examination menu;
a musculoskeletal examination menu;
a neurological examination menu;
a psychiatric examination menu;
a respiratory examination menu; and
a skin examination menu.

18. The CP product of claim 14 further comprising:
means recorded on the recording medium for directing the client computer system to produce for display by the touch-screen an indication when the captured EMD satisfy all predetermined EMD requirements of the Emergency Medicine EMR specification.

19. The CP product of claim 14 wherein the GUI menu items are displayed by the touch-screen as text icons.

20. The CP product of claim 14 further comprising:
means recorded on the recording medium for directing the client computer system to exchange commands and data with a remote server computer.
